(19) United States
(12) Patent Application Publication
(10) Pub. No.: US 2024/0413709 A1
(43) Pub. Date: Dec. 12, 2024

(54) DRIVE DEVICE

(71) Applicant: TOYOTA JIDOSHA KABUSHIKI KAISHA, Toyota-shi (JP)

(72) Inventors: Yusuke SUZUKI, Nisshin-shi (JP); Koichi OKUDA, Toyota-shi (JP); Atsushi TABATA, Okazaki-shi (JP)

(73) Assignee: TOYOTA JIDOSHA KABUSHIKI KAISHA, Toyota-shi (JP)

(21) Appl. No.: 18/643,320

(22) Filed: Apr. 23, 2024

(30) Foreign Application Priority Data
Jun. 7, 2023 (JP) 2023-094158

(51) Int. Cl. H02K 9/193; B60K 7/00; H02K 7/00

(52) U.S. Cl. CPC H02K 9/193; B60K 7/0007; H02K 7/006

(57) ABSTRACT

A drive device includes: a first motor that drives a left wheel; a second motor that drives a right wheel; an oil reservoir; a partition wall provided on a bottom face of the oil reservoir and sections the oil reservoir into a left oil reservoir and a right oil reservoir; a first oil pump that intakes oil from an intake port that opens to a bottom face of the left oil reservoir and supplies sucked oil to the first motor; and a second oil pump that intakes oil from a suction port that opens to a bottom face of the right oil reservoir and supplies sucked oil to the second motor. The partition wall is provided with a through hole extending from the left oil reservoir to the right oil reservoir. A blocking unit for blocking the through hole when acceleration is applied in a lateral direction is provided.

### CROSS-REFERENCE TO RELATED APPLICATION

This application claims priority to Japanese Patent Application No. 2023-094158 filed on Jun. 7, 2023, incorporated herein by reference in its entirety.

### BACKGROUND

### 1. Technical Field

Technology disclosed in the present specification relates to a drive device.

### 2. Description of Related Art

Japanese Unexamined Patent Application Publication No. 2008-283836 (JP 2008-283836 A) discloses an electrified vehicle in which a left wheel and a right wheel are driven by separate electric motors. A drive device of this electrified vehicle has a first electric motor and a second electric motor. Driving force of the first electric motor is transmitted to the left wheel, and driving force of the second electric motor is transmitted to the right wheel.

### SUMMARY

The electrified vehicle is provided with an oil pump for supplying oil to the electric motors. The electric motors are cooled by the oil supplied to the electric motors. In the drive device that has the first electric motor and the second electric motor, a first oil pump that supplies oil to the first electric motor and a second oil pump that supplies oil to the second electric motor can be provided independently. By providing the first oil pump and the second oil pump in this way, the flow rate of the oil supplied to the first electric motor and the flow rate of the oil supplied to the second electric motor can be individually controlled. Accordingly, the temperature of the first electric motor and the temperature of the second electric motor can be appropriately controlled.

When the drive device has the first oil pump and the second oil pump, an intake port of the first oil pump and an intake port of the second oil pump are present on a bottom face of an oil reservoir. When acceleration is applied to the electrified vehicle in a lateral direction, oil in the oil reservoir shifts to either the left or the right. When the oil in the oil reservoir is unevenly distributed in this way, the liquid level of the oil decreases above of either the intake port of the first oil pump or the intake port of the second oil pump, and one or the other of the oil pumps will not be able to perform intake of the oil. In this case, cooling the first electric motor or the second electric motor becomes difficult. In the present specification, a drive device is proposed in which both the first oil pump and the second oil pump can perform suctioning of oil normally even when acceleration acts on the vehicle in the lateral direction.

A drive device disclosed in the present specification includes
a first electric motor that drives a left wheel of a vehicle,
a second electric motor that drives a right wheel of the vehicle,
an oil reservoir,
a partition wall that is provided on a bottom face of the oil reservoir and that sections the oil reservoir into a left oil reservoir and a right oil reservoir,
a first oil pump for sucking oil from an intake port that opens at a bottom face of the left oil reservoir and supplies sucked oil to the first electric motor, and
a second oil pump for sucking oil from an intake port that opens at a bottom face of the right oil reservoir and supplies sucked oil to the second electric motor.
A through hole that extends from the left oil reservoir to the right oil reservoir is provided in the partition wall.
A blocking unit for blocking the through hole when acceleration is applied to the vehicle in a lateral direction, is provided.

In this drive device, the oil reservoir is sectioned into the left oil reservoir and the right oil reservoir by the partition wall. The partition wall is provided with the through hole, and accordingly oil can flow between the left oil reservoir and the right oil reservoir in a normal state. Therefore, in the normal state, the oil is distributed almost uniformly between the left oil reservoir and the right oil reservoir, and both the first oil pump and the second oil pump can appropriately intake the oil. In addition, when acceleration is applied to the vehicle in the lateral direction, the through hole is blocked by the blocking unit. Thus, the oil does not flow between the left oil reservoir and the right oil reservoir. Accordingly, uneven distribution of the oil between the left oil reservoir and the right oil reservoir is suppressed. Therefore, even when acceleration is applied to the vehicle in the lateral direction, a sufficient amount of oil can be stored in the left oil reservoir and the right oil reservoir. Thus, both the first oil pump and the second oil pump can perform appropriate intake of the oil.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a drive device along a left-right direction and a front-rear direction;

FIG. 2 is a longitudinal sectional view of the drive device along A-A of FIG. 1;

FIG. 3 is a longitudinal sectional view of the partition wall 60 and its periphery along the left-right direction;

FIG. 4A shows a variant of a partition wall 60 and an blocking unit;

FIG. 4B shows a variant of a partition wall 60 and an blocking unit;

FIG. 4C shows a variant of a partition wall 60 and an blocking unit; and

FIG. 5 is a diagram illustrating a modified example of the partition wall 60 and the blocking unit.

### DETAILED DESCRIPTION OF EMBODIMENTS

Additional features of the drive device disclosed herein are listed below.

The drive device may further include a first gear immersed in the oil in the left oil reservoir and a second gear immersed in the oil in the right oil reservoir. The first gears may transmit the driving force of the first electric motor to the left wheels. The second gear may transmit the driving force of the second electric motor to the right wheel.

According to this configuration, oil is sprayed into the left oil reservoir by the first gear, and oil is sprayed into the right oil reservoir by the second gear. Each gear is lubricated by the sprayed oil. As described above, when acceleration is applied to the vehicle in the lateral direction, the through hole is closed, and therefore, the liquid level of the oil is hardly lowered in the left oil reservoir and the right oil reservoir. Therefore, even when acceleration is applied to the vehicle in the lateral direction, each gear can disperse oil.

The blocking unit may block the through hole when acceleration is applied to the vehicle in both the lateral direction and the front-rear direction. In this case, the left side surface of the partition wall may be inclined with respect to the front-rear direction, and the right side surface of the partition wall may be inclined in a direction opposite to a direction in which the left side surface is inclined with respect to the front-rear direction.

According to this configuration, the through hole can be closed when the vehicle travels at the corner while accelerating or decelerating.

A partition wall may be arranged in the lateral middle of the oil reservoir. In addition, the partition wall may extend along the front-rear direction of the vehicle.

The blocking unit may include an blocking member disposed at a position opposite to the through hole. The occlusion member may be a plate or a ball. The closure member may be suspended. The plate or the ball may be provided in each of the right oil reservoir and the left oil reservoir.

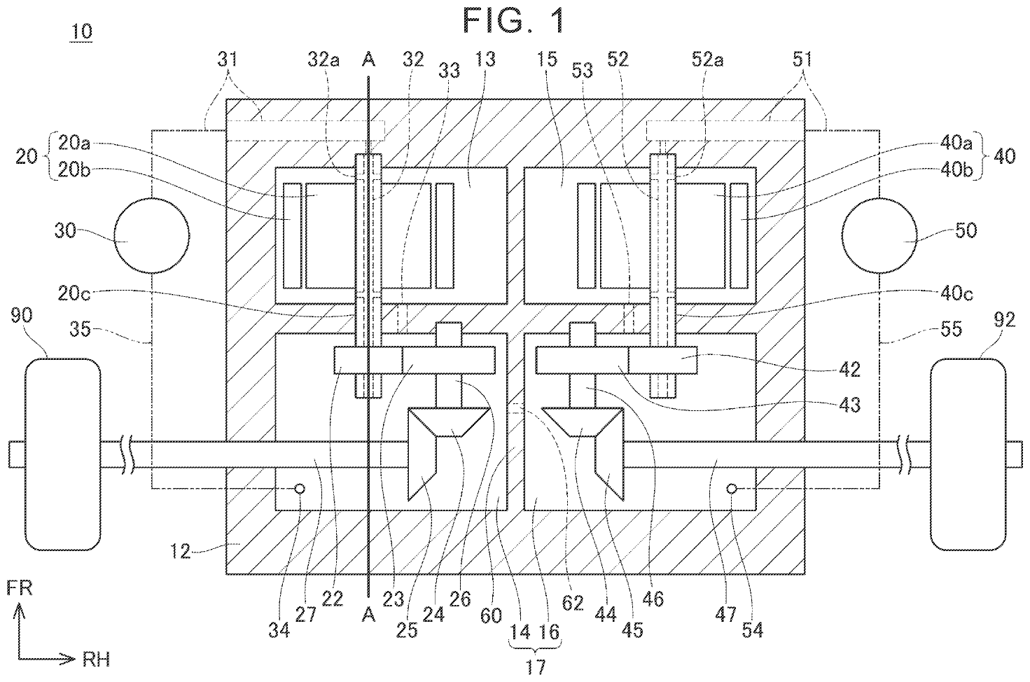

The drive device 10 of the embodiment shown in FIG. 1 is mounted on a electrified vehicle. In FIG. 1, an arrow FR indicates a vehicle front direction, and an arrow RH indicates a vehicle right direction. The drive device 10 drives the left rear wheel 90 and the right rear wheel 92 of electrified vehicle.

The drive device 10 includes a case 12. Inside the case 12, a left electric motor chamber 13, a right electric motor chamber 15, and a gear chamber 17 are provided. The gear chamber 17 also functions as an oil reservoir for storing oil. The gear chamber 17 is sectioned into a left gear chamber 14 and a right gear chamber 16 by a partition wall 60. The partition wall 60 extends along the front-rear direction and is disposed at the middle of the gear chamber 17 in the lateral direction. The left gear chamber 14 is disposed behind the left electric motor chamber 13. The right electric motor chamber 15 is disposed on the right side of the left electric motor chamber 13. The right gear chamber 16 is disposed behind the right electric motor chamber 15. The left electric motor 20 is accommodated in the left electric motor chamber 13. A gear set that transmits the driving force of the left electric motor 20 to the left rear wheel 90 is accommodated in the left gear chamber 14. The right electric motor 40 is accommodated in the right electric motor chamber 15. A gear set that transmits the driving force of the right electric motor 40 to the right rear wheel 92 is accommodated in the right gear chamber 16.

The left electric motor 20 has a rotor 20a and a stator 20b. The rotor 20a has a shaft 20c. The rotor 20a is accommodated in the left electric motor chamber 13 in a direction in which the shaft 20c extends along the front-rear direction of electrified vehicle. The rotor 20a is rotatably supported by a bearing (not shown) provided in the case 12. The shaft 20c passes through a partition wall between the left electric motor chamber 13 and the left gear chamber 14, and extends from the left electric motor chamber 13 to the left gear chamber 14. The stator 20b is disposed around the rotor 20a. When a current flows through the stator 20b, the rotor 20a rotates.

The gear set provided in the left gear chamber 14 has gears 22, 23, 24, 25. A counter shaft 26 and a drive shaft 27 are disposed in the left gear chamber 14. The counter shaft 26 is arranged parallel to the shaft 20c of the rotor 20a. The counter shaft 26 is rotatably indicated by a bearing (not shown) provided in the case 12. The drive shaft 27 extends along the left-right direction of electrified vehicle. The drive shaft 27 extends from the left gear chamber 14 through the left side wall of the case 12 to the outside of the case 12. A left rear wheel 90 is connected to a left end portion of the drive shaft 27. The drive shaft 27 is rotatably indicated by a bearing (not shown) provided in the case 12. The gears 22 are cylindrical gears and are fixed to the shaft 20c of the rotor 20a. The gear 23 is a cylindrical gear and is fixed to the counter shaft 26. The gear 23 is engaged with the gear 22. The gear 24 is a truncated conical gear and is fixed to the counter shaft 26. The gear 25 is a truncated conical gear and is fixed to the drive shaft 27. The gear 25 is engaged with the gear 24. The gear 24 and the gear 25 constitute a hypoid gear.

When the left electric motor 20 is driven to rotate the shaft 20c of the rotor 20a, the gear 22 rotates, and a driving force is transmitted from the gear 22 to the gear 23. Therefore, the gear 23, the counter shaft 26, and the gear 24 rotate. When the gear 24 rotates, a driving force is transmitted from the gear 24 to the gear 25. Therefore, the gear 25 and the drive shaft 27 rotate. As a result, the left rear wheel 90 rotates. As described above, each gear in the left gear chamber 14 transmits the driving force of the left electric motor 20 to the left rear wheel 90.

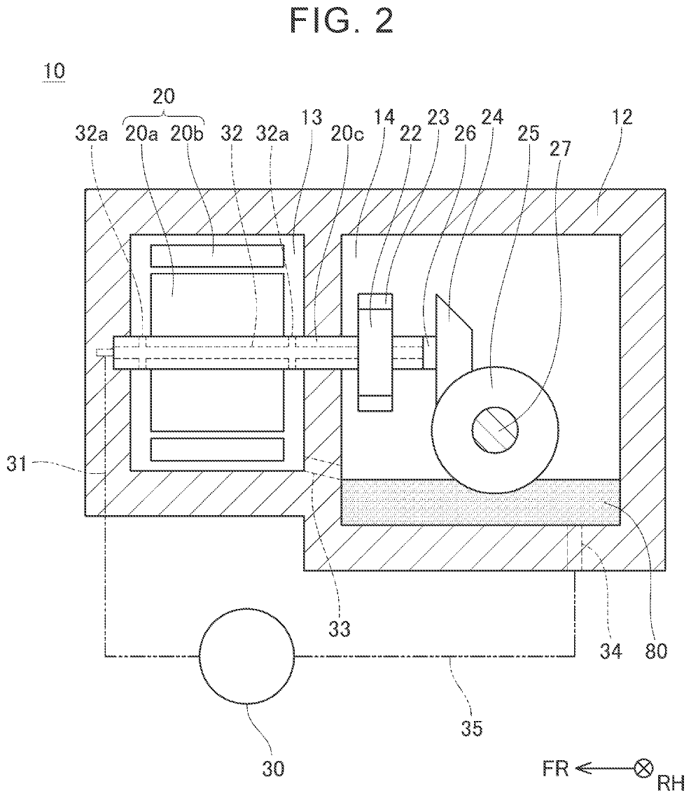

As shown in FIG. 2, the bottom face of the left gear chamber 14 is disposed below the bottom face of the left electric motor chamber 13. Oil 80 is stored in the left gear chamber 14 at a level sufficient to immerse the lower portion of the gear 25. Therefore, when the gear 25 is rotated by the driving of the left electric motor 20, the oil 80 stored in the left gear chamber 14 is flipped up by the gear 25. As a result, oil is sprayed into the left gear chamber 14. Each gear is lubricated by oil sprayed into the left gear chamber 14.

The drive device 10 has a left oil circulation path for circulating oil to the left electric motor chamber 13 and the left gear chamber 14. The left oil circulation path includes an oil pump 30, an oil supply path 31, a shaft flow path 32, an oil flow path 33, an oil suction port 34, and an oil suction path 35. The oil supply path 31 is constituted by a pipe outside the case 12 and a flow path provided inside the outer wall of the case 12. The shaft 20c of the rotor 20a has a cylindrical shape, and the shaft flow path 32 is constituted by a central hole thereof. The shaft flow path 32 extends from the front end to the rear end of the shaft 20c. The oil supply path 31 connects the discharge port of the oil pump 30 and the front end of the shaft flow path 32. A plurality of oil spraying flow paths 32a is provided on the outer peripheral wall of the shaft 20c. The oil flow path 33 passes through a partition wall between the left electric motor chamber 13 and the left gear chamber 14. The oil suction port 34 opens to the bottom face of the left gear chamber 14. The oil suction path 35 is constituted by a pipe outside the case 12. The oil suction path 35 connects the oil suction port 34 and the suction port of the oil pump 30.

When the oil pump 30 operates, the oil 80 stored in the left gear chamber 14 is taken into the oil suction port 34. The oil taken into the oil suction port 34 is supplied to the shaft flow path 32 through the oil suction path 35, the oil pump 30, and the oil supply path 31. In the shaft flow path 32, oil flows from the front end to the rear end of the shaft flow path 32. The oil flowing through the shaft flow path 32 to the rear end is discharged into the left gear chamber 14. In addition, a part of the oil flowing in the shaft flow path 32 is sprayed from the oil spraying flow path 32a into the left electric motor chamber 13. The left electric motor 20 is cooled by the oil flowing in the shaft flow path 32 and the oil sprayed into the left electric motor chamber 13. Further, the rotor 20a is lubricated by the oil sprayed into the left electric motor chamber 13. The oil sprayed into the left electric motor chamber 13 flows through the oil flow path 33 to the left gear chamber 14. As described above, the operation of the oil pump 30 causes the oil to circulate in the left oil circulation path, and the left electric motor 20 is cooled.

The structures in the right electric motor chamber 15 and the right gear chamber 16 are the same as the structures obtained by reversing the structures in the left electric motor chamber 13 and the left gear chamber 14. The right electric motor 40 has a rotor 40a and a stator 40b. The rotor 40a has a shaft 40c. The rotor 40a is accommodated in the right electric motor chamber 15 in a direction in which the shaft 40c extends along the front-rear direction of electrified vehicle. The rotor 40a is rotatably supported by a bearing (not shown) provided in the case 12. The shaft 40c passes through a partition wall between the right electric motor chamber 15 and the right gear chamber 16, and extends from the right electric motor chamber 15 to the right gear chamber 16. The stator 40b is disposed around the rotor 40a. When a current flows through the stator 40b, the rotor 40a rotates.

The gear set provided in the right gear chamber 16 includes gears 42, 43, 44, and 45. A counter shaft 46 and a drive shaft 47 are disposed in the right gear chamber 16. The counter shaft 46 is arranged parallel to the shaft 40c of the rotor 40a. The counter shaft 46 is rotatably indicated by a bearing (not shown) provided in the case 12. The drive shaft 47 extends along the left-right direction of electrified vehicle. The drive shaft 47 extends from the right gear chamber 16 through the right side wall of the case 12 to the outside of the case 12. A right rear wheel 92 is connected to the right end of the drive shaft 47. The drive shaft 47 is rotatably indicated by a bearing (not shown) provided in the case 12. The gears 42 are cylindrical gears and are fixed to the shaft 40c of the rotor 40a. The gear 43 is a cylindrical gear and is fixed to the counter shaft 46. The gear 43 is engaged with the gear 42. The gear 44 is a conical gear and is fixed to the counter shaft 46. The gear 45 is a conical gear and is fixed to the drive shaft 47. The gear 45 is engaged with the gear 44. The gear 44 and the gear 45 constitute a hypoid gear.

When the shaft 40c rotates due to the driving of the right electric motor 40, the driving force is transmitted from the shaft 40c to the drive shaft 47 via the gears 42, 43, 44, and 45. As a result, the drive shaft 47 rotates, and the right rear wheel 92 rotates. As described above, each gear in the right gear chamber 16 transmits the driving force of the right electric motor 40 to the right rear wheel 92.

As in FIG. 2, the bottom face of the right gear chamber 16 is disposed below the bottom face of the right electric motor chamber 15. Oil is stored in the right gear chamber 16 at a level sufficient to immerse the lower portion of the gear 45. Therefore, when the gear 45 is rotated by the driving of the right electric motor 40, the oil stored in the right gear chamber 16 is flipped up by the gear 45. As a result, oil is sprayed into the right gear chamber 16. The respective gears are lubricated by oil sprayed into the right gear chamber 16.

The drive device 10 has a right oil circulation path for circulating oil in the right electric motor chamber 15 and the right gear chamber 16. The right oil circulation path includes an oil pump 50, an oil supply path 51, a shaft flow path 52, an oil flow path 53, an oil suction port 54, and an oil suction path 55. The oil supply path 51 is constituted by a pipe outside the case 12 and a flow passage provided inside the outer wall of the case 12. The shaft 40c of the rotor 40a has a cylindrical shape, and the shaft flow path 52 is constituted by a central hole thereof. The shaft flow path 52 extends from the front end to the rear end of the shaft 40c. The oil supply path 51 connects the discharge port of the oil pump 50 and the front end of the shaft flow path 52. A plurality of oil spraying flow paths 52a is provided on the outer peripheral wall of the shaft 40c. The oil flow path 53 passes through a partition wall between the right electric motor chamber 15 and the right gear chamber 16. The oil suction port 54 opens to the bottom face of the right gear chamber 16. The oil suction path 55 is constituted by a pipe outside the case 12. The oil suction path 55 connects the oil suction port 54 to the suction port of the oil pump 50.

When the oil pump 50 operates, the oil stored in the right gear chamber 16 is supplied to the shaft flow path 52 through the oil suction port 54, the oil suction passage 55, the oil pump 50, and the oil supply path 51. The oil flowing from the front end to the rear end in the shaft flow path 52 is discharged into the right gear chamber 16. In addition, a part of the oil flowing in the shaft flow path 52 is sprayed from the oil spraying flow path 52a into the right electric motor chamber 15. The right electric motor 40 is cooled by the oil flowing in the shaft flow path 52 and the oil sprayed into the right electric motor chamber 15. Further, the rotor 40a is lubricated by the oil sprayed into the right electric motor chamber 15. The oil sprayed into the right electric motor chamber 15 flows through the oil flow path 53 to the right gear chamber 16. As described above, the operation of the oil pump 50 circulates oil in the right oil circulation path, and the right electric motor 40 is cooled.

The partition wall 60 is provided with a through hole 62. The through hole 62 extends from the left gear chamber 14 to the right gear chamber 16. Therefore, oil can flow between the left gear chamber 14 and the right gear chamber 16 through the through hole 62.

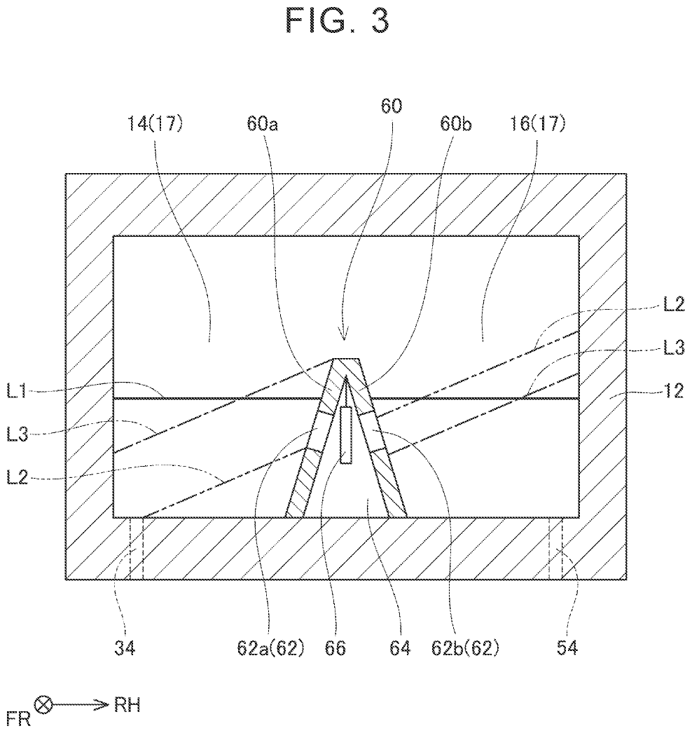

FIG. 3 shows a cross section of the partition wall 60. As shown in FIG. 3, the partition wall 60 is erected on the bottom face of the gear chamber 17. A space is provided between the partition wall 60 and the ceiling surface of the gear chamber 17. Therefore, the left gear chamber 14 and the right gear chamber 16 are connected to each other at an upper portion of the partition wall 60. However, the partition wall 60 may extend to the ceiling surface of the gear chamber 17. The partition wall 60 includes a left side plate 60a and a right side plate 60b. The upper end of the left side plate 60a and the upper end of the right side plate 60b are connected to each other. A space 64 is provided between the left side plate 60a and the right side plate 60b (i.e., inside the partition wall 60). A through hole 62a is provided in the left side plate 60a, and a through hole 62b is provided in the right side plate 60b. The through hole 62a, 62b forms a through hole 62 that passes through the partition wall 60 in the left-right direction. A baffle plate 66 is disposed in a space 64 inside the partition wall 60. The baffle plate 66 is suspended from the upper end of the partition wall 60. The baffle plate 66 extends along the front-rear direction of the vehicle. The baffle plate 66 is disposed between the through holes 62a, 62b. That is, the baffle plate 66 is disposed at a position facing the through hole 62a, 62b. In the normal state (that is, the vehicle is not accelerated), the baffle plate 66 does not block the through hole 62a, 62b. The baffle plate 66 can swing left and right about the upper end of the partition wall 60.

The line L1 in FIG. 3 indicates the position of the liquid level of the oil in a normal state (that is, a state where no acceleration is applied to the vehicles). The liquid level of the oil is located above the through hole 62a, 62b. In FIG. 3, the liquid level of the oil is located below the upper end of the partition wall 60, but the liquid level of the oil may be located above the upper end of the partition wall 60. Normally, since the baffle plate 66 does not block the through hole 62a, 62b, the liquid level of the oil is equal between the left gear chamber 14 and the right gear chamber 16.

Acceleration is applied laterally to the vehicle, such as when the vehicle is traveling on a curve. When the acceleration is applied to the oil in the lateral direction, the distribution of the oil in the gear chamber 17 changes. The line L2, L3 in FIG. 3 indicates the liquid level of the oil when the vehicle is accelerated rightward. Note that the line L2 represents the case where the baffle plate 66 is not present as a comparative example, and the line L3 represents the case where the baffle plate 66 is present.

When the baffle plate 66 is not present, the through hole 62 is not blocked. Accordingly, when an acceleration is applied to the oil in the right direction, the oil flows from the left gear chamber 14 to the right gear chamber 16 through the through hole 62. Therefore, as shown in the line L2 of FIG. 3, the liquid level of the oil in the right gear chamber 16 increases, and the liquid level of the oil in the left gear chamber 14 decreases. Therefore, in FIG. 3, the oil suction port 34 is exposed from the oil. When the oil suction port 34 is exposed in this way, oil cannot be supplied to the left electric motor 20 by the oil pump 30, and it becomes difficult to cool the left electric motor 20. When the liquid level of the oil in the left gear chamber 14 decreases, the entire gear 25 is exposed from the oil, and the oil cannot be sprayed by the gear 25. This reduces the lubricity of the gear in the left gear chamber 14. Similarly, when acceleration is applied to the oil in the leftward direction, cooling of the right electric motor 40 becomes difficult, and the lubricity of the gear in the right gear chamber 16 decreases.

On the other hand, when the baffle plate 66 is present (that is, in the embodiment), the baffle plate 66 swings to the right to close the through hole 62b when the vehicle is accelerated rightward. Therefore, oil is prevented from flowing from the left gear chamber 14 to the right gear chamber 16. This prevents a decrease in the level of the oil in the left gear chamber 14. Therefore, as shown in the line L3 of FIG. 3, the oil suction port 34 is prevented from being exposed from the oil. Therefore, oil can be supplied to the left electric motor 20 by the oil pump 30, and the left electric motor 20 can be suitably cooled. In addition, since a decrease in the liquid level of the oil in the left gear chamber is prevented, the oil can be sprayed into the left gear chamber 14 by the gear 25. That is, a decrease in the lubricity of the gear in the left gear chamber 14 does not occur. Similarly, when the oil is accelerated leftward, the baffle plate 66 swings leftward to close the through hole 62a. Therefore, oil can be supplied to the right electric motor 40 by the oil pump 50, and the right electric motor 40 can be suitably cooled. In addition, there is no decrease in the lubricity of the gear in the right gear chamber 16.

As described above, according to the drive device 10 of the embodiment, even when acceleration is applied to the vehicle in the lateral direction, both the oil pump 30 and the oil pump 50 can appropriately intake the oil, and the left electric motor 20 and the right electric motor 40 can be appropriately cooled.

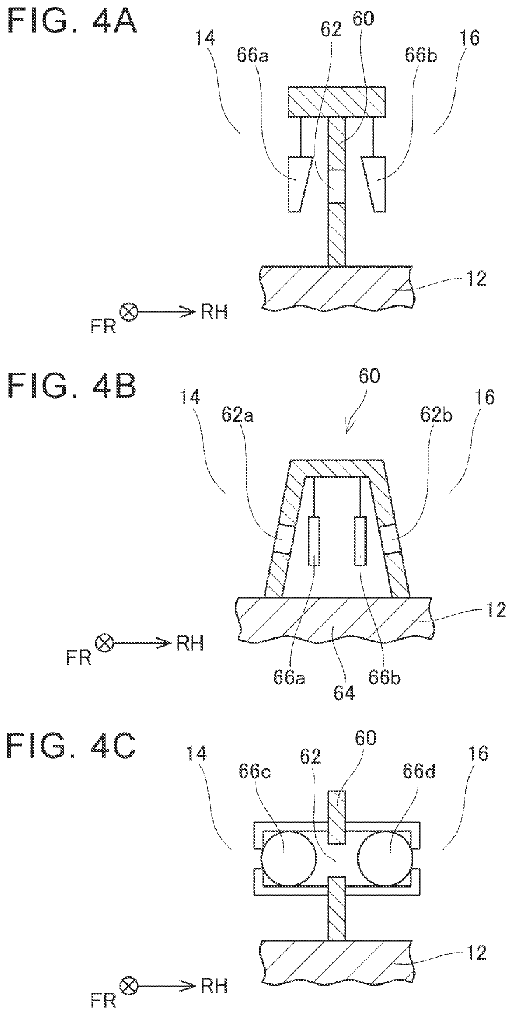

The baffle plate 66 is an example of an blocking unit that blocks the through hole 62 when acceleration is applied in the lateral direction. The blocking unit may have any configuration as long as it can block the through hole 62 when acceleration is applied in the lateral direction. FIGS. 4A to 4C show a variation of the partition wall 60 and the blocking unit.

In FIG. 4A, the partition wall 60 is constituted by a single plate. A baffle plate 66a is disposed on the left side of the through hole 62 penetrating the partition wall 60, and a baffle plate 66b is disposed on the right side of the through hole 62. When the acceleration is applied to the right direction, the baffle plate 66a swings to the right side to close the through hole 62, and when the acceleration is applied to the left direction, the baffle plate 66b swings to the left side to close the through hole 62.

In FIG. 4B, two baffle plate 66a, 66b are arranged in a space 64 inside the partition wall 60. When acceleration is applied to the right direction, the baffle plate 66b swings to the right side to close the through hole 62b, and when acceleration is applied to the left direction, the baffle plate 66a swings to the left side to close the through hole 62a.

In FIG. 4C, the partition wall 60 is constituted by a single plate. A ball 66c is disposed on the left side of the through hole 62 penetrating the partition wall 60, and a ball 66d is disposed on the right side of the through hole 62. The ball 66c, 66d are movable to the left and right by guide rails. Normally, the ball 66c, 66d are disposed at positions away from the partition wall 60, and do not block the through hole 62. When the acceleration is applied to the right direction, the ball 66c moves to the right side to close the through hole 62, and when the acceleration is applied to the left direction, the ball 66d moves to the left side to close the through hole 62.

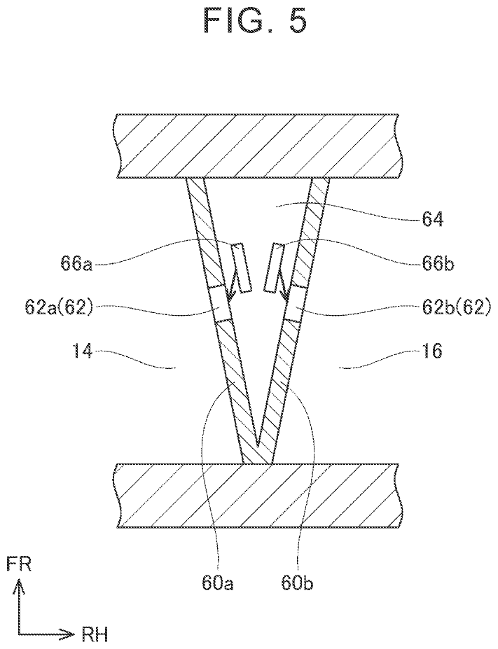

FIG. 5 shows a variation of the partition wall 60 and the blocking unit. In FIG. 5, the left side plate 60a is arranged so as to be displaced to the left side toward the front side, and the right side plate 60b is arranged so as to be displaced to the right side toward the front side. Two baffle plate 66a, 66b are arranged in the space 64 inside the partition wall 60. The baffle plate 66a faces the through hole 62a, and the baffle plate 66b faces the through hole 62b. The center of the baffle plate 66a is located on the front side of the center of the through hole 62a, and the center of the baffle plate 66b is located on the front side of the center of the through hole 62b. The baffle plate 66b closes the through hole 62b when acceleration is applied to the right obliquely rearward direction (that is, when acceleration is applied to both the right direction and the rear direction), and the baffle plate 66a closes the through hole 62a when acceleration is applied to the left obliquely rearward direction (that is, when acceleration is applied to both the left direction and the rear direction). As described above, in the configuration of FIG. 5, the through hole 62 is closed when acceleration is applied simultaneously in the lateral direction and the rearward direction. When the oil suction ports 34 and 54 are disposed at positions close to the front end of the gear chamber 17, the oil suction ports 34 and 54 are easily exposed from the oil when acceleration is applied to the oil in the rearward direction (that is, when the vehicle is accelerating). In such a case, the configuration of FIG. 5 may be adopted so that the through hole 62 is closed when acceleration is applied simultaneously in the lateral direction and the rearward direction. Further, by reversing the configuration of FIG. 5, the through hole 62 can be closed when acceleration is applied to the oil in the lateral direction and the forward direction at the same time.

In the above-described embodiment, the gear chamber 17 functions as an oil reservoir for storing oil supplied to the oil pumps 30 and 50. However, an oil reservoir may be provided separately from the gear chamber 17.

Further, in the above-described embodiment, the electric motor is cooled by the oil discharged by the oil pump flowing inside the shaft of the rotor. However, if the electric motor can be cooled, the oil may be supplied from the oil pump to the electric motor in any form. For example, oil may be discharged from the oil supply path toward the outer peripheral surface of the rotor.

Although the embodiments have been described in detail above, the embodiments are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or the drawings achieve a plurality of objectives at the same time, and achieving one of the objectives itself has technical usefulness.

What is claimed is:

1. A drive device, comprising:
a first electric motor that drives a left wheel of a vehicle;
a second electric motor that drives a right wheel of the vehicle;
an oil reservoir,
a partition wall that is provided on a bottom face of the oil reservoir and that sections the oil reservoir into a left oil reservoir and a right oil reservoir;
a first oil pump for sucking oil from an intake port that opens at a bottom face of the left oil reservoir and supplies sucked oil to the first electric motor;
a second oil pump for sucking oil from an intake port that opens at a bottom face of the right oil reservoir and supplies sucked oil to the second electric motor, wherein
a through hole that extends from the left oil reservoir to the right oil reservoir is provided in the partition wall, and
a blocking unit for blocking the through hole when acceleration is applied to the vehicle in a lateral direction, is provided.

2. The drive device according to claim 1, further comprising:
a first gear that is immersed in oil in the left oil reservoir and that transmits a driving force of the first electric motor to the left wheel; and
a second gear that is immersed in oil in the right oil reservoir and that transmits a driving force of the second electric motor to the right wheel.

3. The drive device according to claim 1, wherein the blocking unit blocks the through hole when acceleration is applied to the vehicle in both the lateral direction and a front-rear direction.

4. The drive device according to claim 1, wherein the partition wall is disposed at a middle of the oil reservoir in the lateral direction.

5. The drive device according to claim 1, wherein the partition wall extends along a front-rear direction of the vehicle.
